(19) United States
(12) Patent Application Publication
(10) Pub. No.: US 2025/0337954 A1
(43) Pub. Date: Oct. 30, 2025

(54) METHOD, APPARATUS, AND MEDIUM FOR POINT CLOUD CODING

(71) Applicants: Douyin Vision Co., Ltd., Beijing (CN); Bytedance Inc., Los Angeles, CA (US)

(72) Inventors: Yingzhan Xu, Beijing (CN); Kai Zhang, Los Angeles, CA (US); Li Zhang, Los Angeles, CA (US)

(21) Appl. No.: 19/263,296

(22) Filed: Jul. 8, 2025

Related U.S. Application Data
(63) Continuation of application No. PCT/CN2024/071181, filed on Jan. 8, 2024.

(30) Foreign Application Priority Data
Jan. 9, 2023 (WO) PCT/CN2023/071450

(51) Int. Cl. H04N 19/597; H04N 19/109; H04N 19/169; H04N 19/96

(52) U.S. Cl. CPC H04N 19/597; H04N 19/109; H04N 19/1883; H04N 19/96

(57) ABSTRACT

Embodiments of the present disclosure provide a solution for point cloud coding. A method for point cloud coding is proposed. The method comprises: performing a conversion between a point cloud sequence and a bitstream of the point cloud sequence, wherein an output order of a plurality of point cloud (PC) samples of the point cloud sequence is dependent on time stamps of the plurality of PC samples.

### CROSS REFERENCE TO RELATED APPLICATIONS

This application is a continuation of International Application No. PCT/CN2024/071181, filed on Jan. 8, 2024, which claims the benefit of International Application No. PCT/CN2023/071450, filed on Jan. 9, 2023. The entire contents of these applications are hereby incorporated by reference in their entireties.

### FIELDS

Embodiments of the present disclosure relates generally to point cloud coding techniques, and more particularly, to multi-reference inter prediction for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding quality and coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: performing a conversion between a point cloud sequence and a bitstream of the point cloud sequence, wherein an output order of a plurality of point cloud (PC) samples of the point cloud sequence is dependent on time stamps of the plurality of PC samples.

Based on the method in accordance with the first aspect of the present disclosure, the output order of PC samples is dependent on time stamps of the PC samples. Compared with the conventional solution where the output order is dependent on the number of times that each PC sample is reference by other PC samples, the proposed method can advantageously enable outputting the PC samples according to a display order, and thus avoid a mismatch between the output order and the display order. Thereby, the coding quality can be improved.

In a second aspect, another method for point cloud coding is proposed. The method comprises: performing a conversion between a current point cloud (PC) sample of a point cloud sequence and a bitstream of the point cloud sequence, wherein a prediction direction for a current node in the current PC sample is indicated in the bitstream, the prediction direction corresponds to a first reference PC sample in a plurality of reference PC samples for the current PC sample, and a reference node in the first reference PC sample is used to determine a prediction of geometry information of the current node.

Based on the method in accordance with the first aspect of the present disclosure, the prediction direction for a node is indicated in the bitstream. Compared with the conventional solution where the prediction direction is determined at both an encoder and a decoder, the proposed method can advantageously improve the coding efficiency.

In a third aspect, an apparatus for point cloud coding is proposed. The apparatus comprises a processor and a non-transitory memory with instructions thereon. The instructions upon execution by the processor, cause the processor to perform a method in accordance with the first aspect of the present disclosure.

In a fourth aspect, a non-transitory computer-readable storage medium is proposed. The non-transitory computer-readable storage medium stores instructions that cause a processor to perform a method in accordance with the first aspect of the present disclosure.

In a fifth aspect, another non-transitory computer-readable recording medium is proposed. The non-transitory computer-readable recording medium stores a bitstream of a point cloud sequence which is generated by a method performed by an apparatus for point cloud coding. The method comprises: performing a conversion between the point cloud sequence and the bitstream, wherein an output order of a plurality of point cloud (PC) samples of the point cloud sequence is dependent on time stamps of the plurality of PC samples.

In a sixth aspect, a method for storing a bitstream of a point cloud sequence is proposed. The method comprises: performing a conversion between the point cloud sequence and the bitstream, wherein an output order of a plurality of point cloud (PC) samples of the point cloud sequence is dependent on time stamps of the plurality of PC samples; and storing the bitstream in a non-transitory computer-readable recording medium.

In a seventh aspect, another non-transitory computer-readable recording medium is proposed. The non-transitory computer-readable recording medium stores a bitstream of a point cloud sequence which is generated by a method performed by an apparatus for point cloud coding. The method comprises: performing a conversion between a current point cloud (PC) sample of the point cloud sequence and the bitstream, wherein a prediction direction for a current node in the current PC sample is indicated in the bitstream, the prediction direction corresponds to a first reference PC sample in a plurality of reference PC samples for the current PC sample, and a reference node in the first reference PC sample is used to determine a prediction of geometry information of the current node.

In an eighth aspect, a method for storing a bitstream of a point cloud sequence is proposed. The method comprises: performing a conversion between a current point cloud (PC) sample of the point cloud sequence and the bitstream, wherein a prediction direction for a current node in the current PC sample is indicated in the bitstream, the prediction direction corresponds to a first reference PC sample in a plurality of reference PC samples for the current PC sample, and a reference node in the first reference PC sample is used to determine a prediction of geometry information of the current node; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of inter prediction for predictive geometry coding;

FIG. 5 illustrates an example of deriving the prediction direction of child nodes;

FIG. 6 illustrates an example of bi-prediction under predictive tree geometry coding;

FIG. 7 illustrates a flowchart of a method for point cloud coding in accordance with embodiments of the present disclosure;

FIG. 8 illustrates a flowchart of a method for point cloud coding in accordance with embodiments of the present disclosure; and

FIG. 9 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

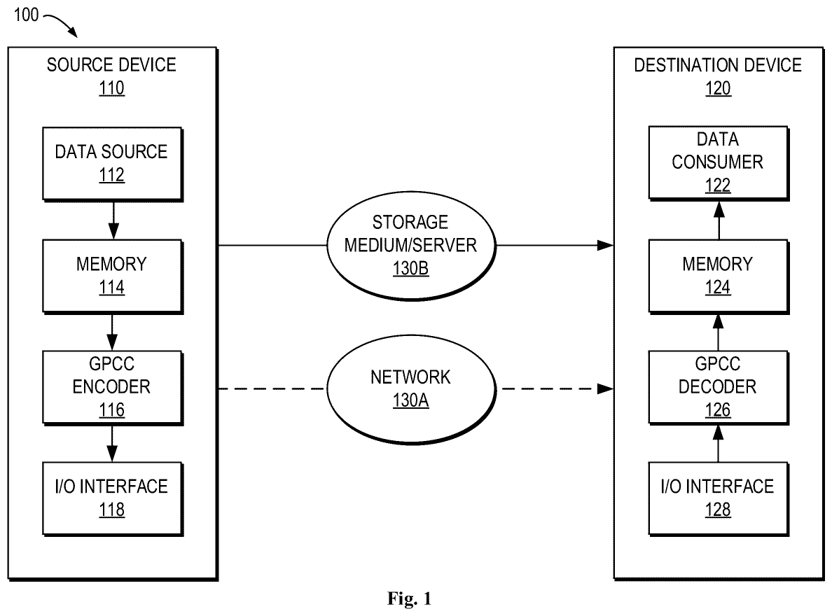

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

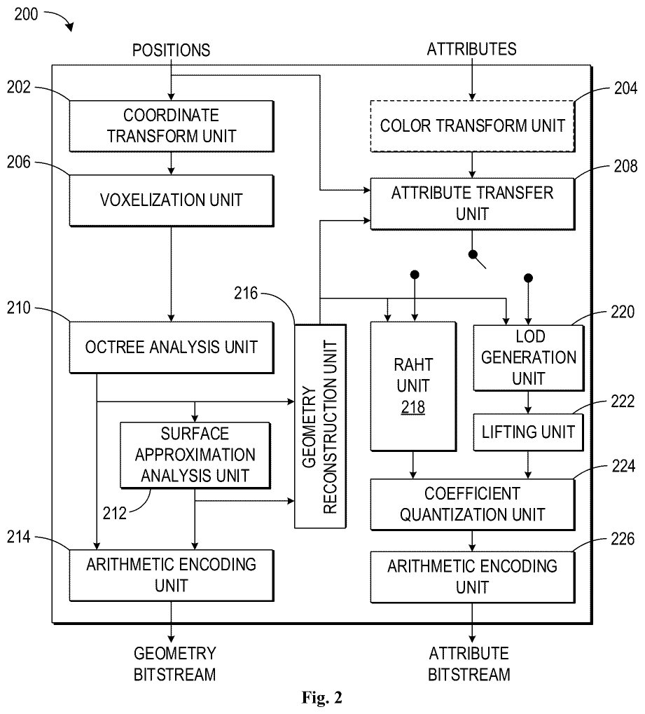

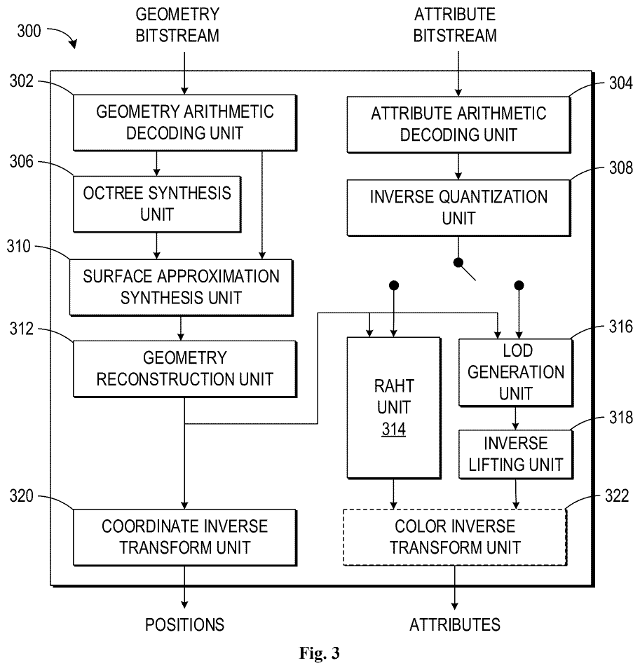

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Brief Summary

This disclosure is related to point cloud coding technologies. Specifically, it is about multi-reference inter prediction in point cloud compression. The ideas may be applied individually or in various combination, to any point cloud coding standard or non-standard point cloud codec, e.g., the being-developed Geometry based Point

Cloud Compression (G-PCC).

### 2. Abbreviations

G-PCC Geometry based Point Cloud Compression
MPEG Moving Picture Experts Group
3DG 3D Graphics Coding Group
CFP Call for Proposal
V-PCC Video-based Point Cloud Compression
CE Core Experiment
EE Exploration Experiment
inter-EM inter Exploration Model
GOF Group of Frame
RDO Rate Distortion Optimization
GM Global Motion
QP Quantization Parameter
RA Random Access
FIFO First In First Out
OC Occupancy Code
POC Picture Order Count
PC Point Cloud

### 3. Introduction

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG and put into the reference software named inter Exploration Model (inter-EM).

In one point cloud frame, there are many data points to describe the 3D objects or scenes. For each data point, there may be corresponding geometry information and attribute information. Geometry information is used to record the spatial location of the data point. Attribute information is used to record more details of the data point, such as texture, normal vector and reflection. In inter-EM, there are some optional tools to support the inter prediction coding and decoding of geometry information and attribute information respectively.

For attribute information, the codec uses the attribute information of the reference points to perform the inter prediction for each point in current frame. The reference points are selected from the data points in current frame and reference frame based on the geometric distance of points. Each reference point corresponds to one weight value which is based on the geometric distance from the current point. The predicted attribute value can be the weighted average value of or one of the attribute values of the reference points. The decision on predicted attribute value is based on Rate Distortion Optimization (RDO) methods.

For geometry information, there are two main methods to perform the inter prediction coding, which are octree based method and predictive tree based method.

In the first method, the geometry information is represented by octree structures and the occupancy code (OC) of each node. For each node in the octree of the current frame, the codec will decide whether to perform octagonal division or not based on the number of points in the current node. The same division will be performed on the corresponding reference node in the reference frame. At the same time, the occupancy codes of the current node and the reference node will be calculated. The codec will use the occupancy code of the reference node to perform the prediction coding for the occupancy code of the current node.

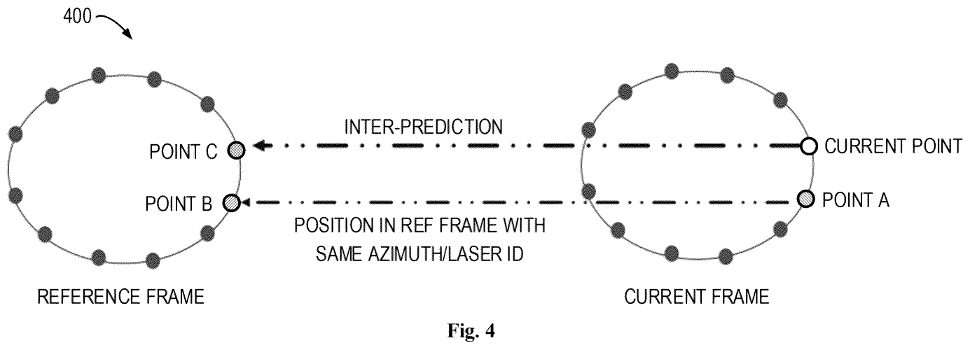

In the second method, the points in the point cloud are sorted to form a predictive tree. FIG. 4 illustrates an example of inter prediction for predictive geometry coding. As shown in FIG. 4, for each point, the previous decoded point will be chosen as point A. Then the point in the reference frame with the same scaled azimuth and laser ID as point A will be selected as point B. At last, the point in the reference frame which is the first point that has scaled azimuth greater than that of point B will be chosen as point C. The codec will use the geometry information of the point C to perform the prediction coding for the geometry information of the current point. In current inter-EM, the IPPP structure is applied which means that the reference frame of the current frame is the previous frame if the current frame applies inter prediction. At the same time, inter-EM uses quantization parameters (QP) to control the bit rate points and all frames share the same QP values.

### 3.1 Multiple-reference Inter Prediction

The multiple-reference inter prediction was researched and the related tools were adopted to the G-PCC v2. The B-frame and related inter prediction mode were proposed and studied in this work.

It is proposed to use a hierarchical GOF structure to perform the inter prediction for geometry coding and attribute coding. In the hierarchical GOF structure, the first frame in each GOF is an I-frame or a P-frame. The other frames in the GOF are B-frames, which use two reference frames from the forward and backward directions. For octree geometry coding, the prediction direction of the child nodes of the current node are derived based on the relationship between the occupancy codes of the current node and those of the reference nodes.

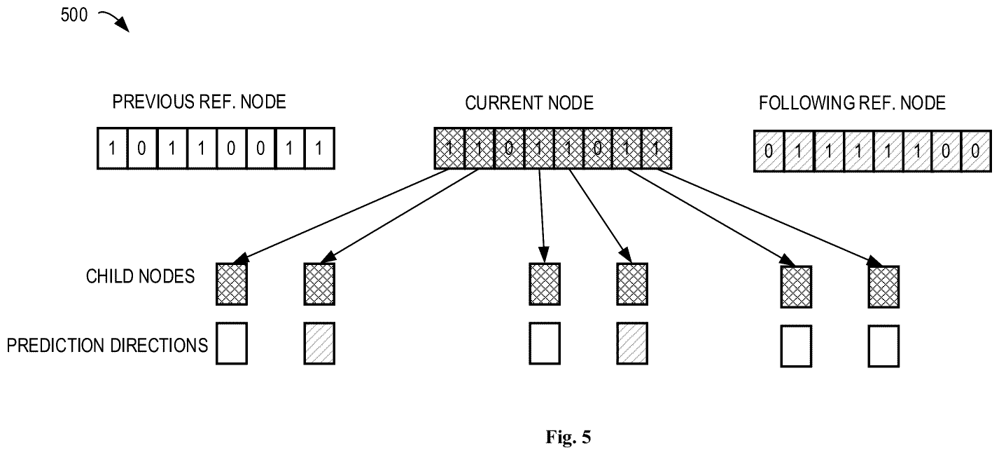

FIG. 5 shows an example of how to derive the prediction direction. For a child node of the current node with the occupancy flag equal to 1, the corresponding occupancy flags of the previous reference frame and the following reference frame are denoted as bit_pre and bit_follow, respectively Then the prediction direction of the current node is derived following the rules as below.
If bit_pre=1 and bit_follow=0, the prediction direction of the child node is set to using the previous reference (forward) node to perform inter prediction.
If bit_pre=0 and bit_follow=1, the prediction direction of the child node is set to using the following reference (backward) node to perform inter prediction.
If bit_pre=bit_follow=1, the numbers of the mismatched bits between the occupancy code of current node and the occupancy codes of the reference nodes are calculated. If the numbers of the mismatched bits are different, the prediction direction of the child node is set to the prediction direction with less mismatched number. Otherwise, the prediction direction of the child node is set to the prediction direction of the parent node.

### 4. Problems

The existing Designs for xxx Have the Following Problems
1. In current design, the output order of point cloud frames is determined by the reference time of each frame. If one frame is not used as reference frame for any other frames, the frame is determined to be outputted. However, there is mismatch between the output order and the display order, which will introduce latency between decoding and display.
2. In current design, the prediction direction of each child node is only determined by the occupancy information of the parent node. However, the difference in the occupancy code of the parent node cannot fully reflect the difference in the geometry information of the child nodes. The determining is not efficient so that the prediction efficiency is not good enough.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner. In the following discussions, the term “PC sample” refer to the unit that performs prediction coding in the point cloud sequence coding, such as frame/picture/slice/tile/subpicture/node/point/other units that contains one or more nodes or points.
1) It is proposed to output the decoded point cloud samples according to the display order of the decoded point cloud samples.
   a. In one example, the display order may be consistent with decoding order, such as when B-frame is disabled.
      i. In one example, the output order may be consistent with the decoding order.
   b. In one example, the display order may be different with decoding order, such as when B-frame is enabled.
      i. In one example, the output order may be different with the decoding order.
      ii. In one example, there may be at least one indicator to indicate whether one decoded point cloud sample should be outputted.
         1. In one example, the indicator may be derived based on the time stamp of the previous one outputted point cloud sample.
         a. In one example, the indicator may be indicated as output, when the time stamp of the decoded point cloud sample is equal to the sum of the time stamp of the previous one outputted point cloud sample and time stamp step (such as 1).
         2. In one example, the indicator may be derived based on the reference time of the decoded point cloud sample.
         a. In one example, the reference time is the number of times the point cloud sample is referenced by other point cloud samples that are not already decoded.
         b. In one example, the indicator may be indicated as output, when the reference time of the decoded point cloud sample is equal to 0.
         3. In one example, the indicator may be indicated as no output when the decoded point cloud sample is already outputted.
         4. The above descriptions may be combined to derive the indicator.
      iii. In one example, the indicators may be derived at the decoder.
      iv. In one example, the indicators may be updated during the decoding process.
      v. In one example, the decoded point cloud sample may be outputted when the indicator is indicated as output.
2) It is proposed to derive the prediction direction of one node based on the planar information of the parent node and the reference parent nodes.
   a. In one example, for each node in the octree, there is one parent node.
   b. In one example, for each parent node, there may be multiple reference parent nodes.
   c. In one example, the planar information of one node is used to indicate the point distributions in the half node space divided along a certain direction (such as x/y/z axis direction).
      i. In one example, there may be two indicators to indicate the planar information for the two half node spaces divided along x axis direction respectively.
      ii. In one example, there may be two indicators to indicate the planar information for the two half node spaces divided along y axis direction respectively.
      iii. In one example, there may be two indicators to indicate the planar information for the two half node spaces divided along z axis direction respectively.
   d. In one example, the planar information of the parent node and reference parent nodes may be used to derive the prediction direction of each child node of the parent node.
      i. In one example, each prediction direction is related to one reference parent node and the corresponding reference child node in the reference parent node.
      ii. In one example, the difference between the planar information of the parent node and each reference parent node may be derived.
      iii. In one example, the difference on planar information may be used to derive the prediction direction.
         1. In one example, the prediction direction may be set to the direction with a less difference on planar information.
      iv. In one example, the difference on planar information may be combined with other information (such as occupancy information, mismatch number of occupancy bits, etc.) to derive the prediction direction.
3) It is proposed to derive the prediction direction of one node based on the occupancy information of the current node and the reference nodes.
   a. In one example, for each node in octree, there may be multiple reference nodes.
   b. In one example, for each node or reference node, there may be one occupancy code to indicate the occupancy information.
   c. In one example, each prediction direction is related to one reference node.
   d. In one example, the difference between the occupancy codes of the node and each reference node may be derived.
   e. In one example, the difference on occupancy codes may be used to derive the prediction direction.
      i. In one example, the prediction direction may be set to the direction with a less difference on occupancy codes.
   f. In one example, the different on occupancy codes may be combined with other information (such as the occupancy information of parent node level, mismatch number of occupancy bits of parent node level, etc.) to derive the prediction direction.
4) It is proposed to derive the prediction direction of one node based on the geometry information of the current node and the reference nodes.
   a. In one example, for each node in predictive tree, there may be multiple reference nodes.
   b. In one example, for each node or reference node, the geometry information may be represented in the form of geometric coordinates.
      i. In one example, the geometric coordinates may be in the Euclidean coordinate system.
      ii. In one example, the geometric coordinates may be in the spherical coordinate system.
   c. In one example, each prediction direction is related to one reference node.
   d. In one example, the difference between the geometry information of the node and each reference node may be derived.
   e. In one example, the difference on geometry information may be used to derive the prediction direction.
      i. In one example, the prediction direction may be set to the direction with a less difference on geometry information.
   f. In one example, the different on geometry information may be combined with other information (such as the occupancy information of parent node level, mismatch number of occupancy bits of parent node level, etc.) to derive the prediction direction.
5) It is proposed to signal the prediction direction of each node to the decoder.
   a. In one example, the prediction direction may be derived at the encoder.
   b. In one example, the prediction direction may be conditionally signalled.
      i. In one example, the prediction direction may be signalled when there are multiple reference point cloud samples for the current point cloud sample.
      ii. In one example, the prediction direction may be signalled when there are multiple reference nodes for the current node.
      iii. In one example, the prediction direction may be signalled when there are multiple predictor candidates for the current node.
   c. In one example, for each node, there may be at least one indicator to indicate the prediction direction.
      i. In one example, the indicator may be the frame index of the reference frame which the applied reference node belongs to.
      ii. In one example, the indicator may be the index of the applied candidate value in the predictor candidate list.
      iii. In one example, the indicator may be prediction direction, such as forward prediction is set as 0 and backward prediction is set as 1.
   d. In one example, the indicators may be derived at the encoder.
   e. In one example, the indicators may be signalled to the decoder.
      i. In one example, the indicators may be coded with fixed-length coding, unary coding, truncated unary coding, etc. al.
      ii. In one example, the indicators may be coding in a predictive way.
6) Whether to and/or how to apply a method disclosed above may be signaled from encoder to decoder in a bitstream/frame/tile/slice/octree/etc.
7) Whether to and/or how to apply the disclosed methods above may be dependent on coded information, such as dimensions, colour format, colour component, slice/picture type.

### 6. Embodiments

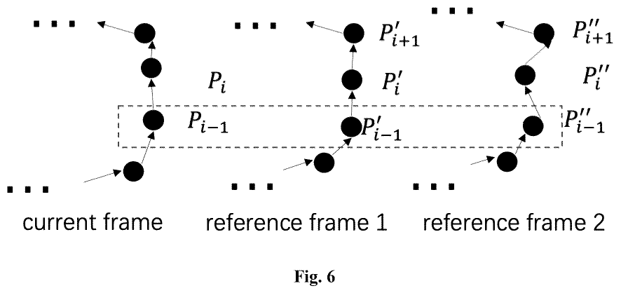

This embodiment describes an example of how the bi-prediction is performed under predictive tree geometry coding. FIG. 6 illustrates an example of bi-prediction under predictive tree geometry coding. At the encoder, for each node Pᵢ in current frame, its parent node Pᵢ₋₁ is firstly found. Secondly, the corresponding nodes of the parent node, P′ᵢ₋₁ and P″ᵢ₋₁ are found in the two reference frames respectively. Thirdly, the four reference nodes of the the current node, P′ᵢ, P′ᵢ₊₁, P″ᵢ₊₁ and Pity are found in the two reference frames repectively. Then the geometry information residual of each reference node is calculated. Lastly, one predictor is selected from the four reference nodes based on the geometry information residual. One indicator is used to indicate the predictor index (0/1/2/3) and the indicator is signalled to the decoder.

More details of the embodiments of the present disclosure will be described below which are related to multi-reference inter prediction. The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a picture, a slice, a sub-frame, a sub-picture, a tile, a segment, or any other suitable processing unit.

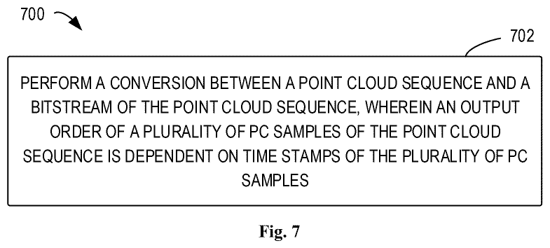

FIG. 7 illustrates a flowchart of a method 700 for point cloud coding in accordance with some embodiments of the present disclosure. At 702, a conversion between a point cloud sequence and a bitstream of the point cloud sequence is performed. In some embodiments, the conversion includes encoding the point cloud sequence into the bitstream. Additionally or alternatively, the conversion includes decoding the point cloud sequence from the bitstream.

Furthermore, an output order of a plurality of point cloud (PC) samples of the point cloud sequence is dependent on time stamps of the plurality of PC samples. For example, the plurality of PC samples may be decoded from the bitstream. In addition, the output order may be determined based on the time stamps of the plurality of PC samples.

In some embodiments, the output order may be the same as a display order of the plurality of PC samples. In other words, the plurality of PC samples may be outputted based on the display order of the plurality of PC samples. The display order may be the same as a time stamp order of the plurality of PC samples.

In view of the above, the output order of PC samples is dependent on time stamps of the PC samples. Compared with the conventional solution where the output order is dependent on the number of times that each PC sample is reference by other PC samples, the proposed method can advantageously enable outputting the PC samples according to a display order, and thus avoid a mismatch between the output order and the display order. Thereby, the coding quality can be improved.

In some embodiments, the display order may be the same as a coding order of the plurality of PC samples. The coding order may be an encoding order or a decoding order. For example, if a bi-directional prediction scheme is disabled for the plurality of PC samples, the display order may be the same as a coding order of the plurality of PC samples. In these cases, the output order of the plurality of PC samples may be the same as the coding order of the plurality of PC samples.

In some embodiments, the display order may be different from a coding order of the plurality of PC samples. For example, if a bi-directional prediction scheme is enabled for at least one of the plurality of PC samples, the display order may be different from a coding order of the plurality of PC samples. In these cases, the output order of the plurality of PC samples may be the different from the coding order of the plurality of PC samples.

In some embodiments, there may be at least one indication for each PC sample in the plurality of PC samples to indicates whether to output this PC sample. For example, a first indication indicates whether to output a first PC sample in the plurality of PC samples. An indication may be implemented as a flag, an index or any other suitable element for signaling information. In some embodiments, the first indication may be determined at a decoder for performing the conversion. Additionally or alternatively, the first indication may be updated during the conversion.

In some embodiments, the first indication may be determined based on a time stamp of the most-recently outputted PC sample. By way of example rather than limitation, if a time stamp of the first PC sample is equal to a sum of a time stamp step (such as 1 or the like) and the time stamp of the most-recently outputted PC sample, the first indication indicates that the first PC sample is to be outputted.

Alternatively, the first indication may be determined based on the time stamp of the most-recently outputted PC sample and a reference metric of the first PC sample. The reference metric of the first PC sample indicates the number of times that the first PC sample is used as a reference PC sample for a PC sample to be coded. As used herein, this reference metric may also be referred to as reference time. By way of example, at the beginning of the coding process, the reference metric of the first PC sample may be five, which indicates that the first PC sample is referenced by five PC samples that have not been coded yet. During the coding process, if one of the five PC samples has been coded, then the reference metric of the first PC sample may be updated to be four. After all of the five PC samples has been coded, the reference metric of the first PC sample may be kept as zero, which indicates that the first PC sample will not be reference by any further PC samples in the remaining coding process.

In some embodiments, if the time stamp of the first PC sample is equal to a sum of a time stamp step (such as 1 or the like) and the time stamp of the most-recently outputted PC sample and the reference metric is equal to first value (such as 0 or the like), the first indication indicates that the first PC sample is to be outputted.

In some embodiments, if the first indication indicates that the first PC sample is to be outputted, the first PC sample may be outputted. Additionally or alternatively, if the first PC sample is already outputted, the first indication may indicate that the first PC sample is not to be outputted.

In aid of the first indication, the output order of PC samples may be controlled based on time stamps of the PC samples. This can advantageously enable outputting the PC samples according to a display order, and thus avoid a mismatch between the output order and the display order. Thereby, the coding quality can be improved.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a conversion between the point cloud sequence and the bitstream is performed. An output order of a plurality of point cloud (PC) samples of the point cloud sequence is dependent on time stamps of the plurality of PC samples.

According to still further embodiments of the present disclosure, a method for storing a bitstream of a point cloud sequence is provided. In the method, a conversion between the point cloud sequence and the bitstream is performed. An output order of a plurality of point cloud (PC) samples of the point cloud sequence is dependent on time stamps of the plurality of PC samples. Moreover, the bitstream is stored in a non-transitory computer-readable recording medium.

In view of the above, the solutions in accordance with some embodiments of the present disclosure can advantageously enable better control of the output order of PC samples.

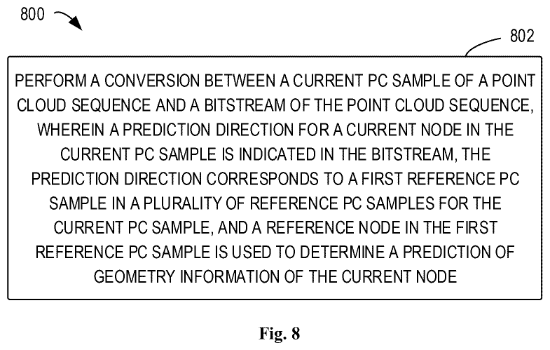

FIG. 8 illustrates a flowchart of a method 800 for point cloud coding in accordance with some embodiments of the present disclosure. At 802, a conversion between a current point cloud (PC) sample of a point cloud sequence and a bitstream of the point cloud sequence is performed. In some embodiments, the conversion includes encoding the current PC sample into the bitstream. Additionally or alternatively, the conversion includes decoding the current PC sample from the bitstream.

Furthermore, a prediction direction for a current node in the current PC sample is indicated in the bitstream. The prediction direction corresponds to a first reference PC sample in a plurality of reference PC samples for the current PC sample, and a reference node in the first reference PC sample is used to determine a prediction of geometry information of the current node. In some embodiments, the prediction direction may be determined at an encoder for performing the conversion, e.g., based on geometry information of the current node and geometry information of each of a plurality of reference nodes for the current node, and/or any other suitable information. This will be described in detail below.

In view of the above, the prediction direction for a node is indicated in the bitstream. Compared with the conventional solution where the prediction direction is determined at both an encoder and a decoder, the proposed method can advantageously improve the coding efficiency.

In some embodiments, the prediction direction may be indicated in the bitstream based on a condition. In one example, if there are a plurality of reference PC samples for the current PC sample, the prediction direction may be indicated in the bitstream. In another example, if there are a plurality of reference nodes for the current node, the prediction direction may be indicated in the bitstream. In a further example, if there are a plurality of candidate predictions (also referred to as predictor candidates herein) for the geometry information of the current node, the prediction direction may be indicated in the bitstream.

In some embodiments, for each node, there may be at least one indication to indicate the prediction direction of the node. For example, the bitstream may comprise a first indication indicating the prediction direction for the current node. In one example, the first indication may be an index of the first reference PC sample. Alternatively, the first indication may be an index of a first candidate prediction in a list of candidate predictions for the geometry information of the current node, and the first candidate prediction is used to code the current node. In a further example, the first indication may be an index of the prediction direction, such as 0 represents forward prediction and 1 represents backward prediction.

In some embodiments, the first indication may be determined at an encoder for performing the conversion. In addition, the first indication may be indicated in the bitstream. In one example, the first indication may be coded with a fixed-length coding. In another example, the first indication may be coded with a unary coding. In a further example, the first indication may be coded with a truncated unary coding. In a still further example, the first indication may be coded in a predictive way.

In some embodiments, the prediction direction for the current node may be determined based on geometry information of the current node and geometry information of each of a plurality of reference nodes for the current node. For example, the current node may be a node in a predictive tree for the current PC sample and represents a single point in the current PC sample. Similarly, each of the plurality of reference nodes may be a node in a predictive tree for the corresponding reference PC sample. In addition, more than one reference node may be determined for each node in the predictive tree. By way of example, with reference to FIG. 6, a part of predictive trees for current frame, reference frame 1 and reference frame 2 are shown. The node Pᵢ₋₁ is a parent node of the node Pᵢ. The nodes P′ᵢ, P′ᵢ₊₁, P″ᵢ, and P″ᵢ₊₁ are reference nodes for the node Pᵢ.

In some embodiments, the geometry information of the current node or the geometry information of each of the plurality of reference nodes may be represented in a form of geometric coordinates. In on example, the geometric coordinates may be in a Euclidean coordinate system. Alternatively, the geometric coordinates may be in a spherical coordinate system.

In some embodiments, the prediction direction for the current node may be determined from a plurality of candidate prediction directions for the current node. Each of the plurality of candidate prediction directions corresponds to one of the plurality of reference PC samples for the current PC sample.

In some embodiments, respective differences between the geometry information of the current node and the geometry information of each of the plurality of reference nodes may be determined. At the encoder side, the actual geometry information of the current node may be used to determine the difference. At the decoder, an initial prediction for the geometry information of the current node may be used to determine the difference. By way of example, the initial prediction may be determined based on geometry information of one or more neighboring node of the current node.

In some embodiments, the prediction direction for the current node may be determined based on the respective differences. By way of example rather than limitation, the prediction direction for the current node may be determined to be one of the plurality of candidate prediction directions that corresponds to a reference PC sample comprising a reference node corresponding to the smallest difference in the respective differences.

In some embodiments, the prediction direction for the current node may be determined further based on any other additional information, such as occupancy information of a parent node level of the current node, the number of mismatch occupancy bits of the parent node level, and/or the like.

In view of the above, the geometry information of the current node and the geometry information of each of the plurality of reference nodes are considered for determining the prediction direction of the current node. Thereby, the determination of the prediction direction can be performed more efficiently, and thus the coding efficiency can be improved.

In some alternative embodiments, the current node may be a node in a tree structure for spatial partition of the current PC sample and represents at least a portion of the current PC sample. For example, the tree structure may be an octree structure or an occupancy tree. Each non-root node in the tree structure may correspond to a parent node.

In some embodiments, more than one reference nodes may be determined for the parent node. Additionally, more than one reference node may be determined for each node in the tree structure. In some embodiments, the prediction direction for the current node may be determined from a plurality of candidate prediction directions for the current node, and each of the plurality of candidate prediction directions corresponds to one of a plurality of reference PC nodes for the current node.

In some embodiments, the prediction direction for the current node may be determined based on planar information of a parent node of the current node and planar information of each of a set of reference nodes for the parent node of the current node. For example, planar information of a node indicates respective point distributions (e.g., occupancy information) in two half node spaces obtained by dividing the node along a direction. By way of example rather than limitation, the direction may be one of the following: an x-axis direction, a y-axis direction, or a z-axis direction. In some embodiments, there may be a plurality of indications indicating the respective point distributions in the two half node spaces.

In some embodiments, the planar information of the parent node of the current node and the planar information of each of the set of reference nodes for the parent node may also be used to determine a prediction direction for each child node of the parent node.

In some embodiments, the prediction direction for the current node may be determined from a plurality of candidate prediction directions for the current node, and each of the plurality of candidate prediction directions corresponds to one of the set of reference nodes for the parent node of the current node and one of a plurality of reference PC nodes for the current node. For example, a first candidate prediction direction may correspond to a first reference node for the parent node of the current node and a reference node for the current node that is comprised in the first reference node. As used herein, a reference node for a parent node of a node may also be referred to as a reference parent node.

In some embodiments, respective differences between the planar information of the parent node of the current node and the planar information of each of the set of reference nodes for the parent node of the current node may be determined. In addition, the prediction direction for the current node may be determined based on the respective differences. By way of example rather than limitation, the prediction direction for the current node may be determined to be one of the plurality of candidate prediction directions that corresponds to one of the set of reference nodes corresponding to the smallest difference in the respective differences.

In some embodiments, the prediction direction for the current node may be determined further based on any other additional information, such as occupancy information of a parent node level of the current node, the number of mismatch occupancy bits of the parent node level, and/or the like.

In view of the above, the planar information of a parent node of the current node and the planar information of each of a set of reference nodes for the parent node of the current node are considered for determining the prediction direction of the current node. Thereby, the determination of the prediction direction can be performed more efficiently, and thus the coding efficiency can be improved.

In some embodiments, the prediction direction for the current node may be determined based on occupancy information of the current node and occupancy information of each of a plurality of reference nodes for the current node. At the encoder side, the actual occupancy information of the current node may be used to determine the difference. At the decoder, an initial prediction for the occupancy information of the current node may be used to determine the difference. By way of example, the initial prediction may be determined based on occupancy information of one or more neighboring node of the current node.

In some embodiments, the occupancy information of the current node or the occupancy information of each of a plurality of reference nodes may be indicated by an occupancy code. For example, the occupancy may be an 8-bit bitmap, whose bits indicate the existence of child nodes at particular locations in the next tree level.

In some embodiments, respective differences between the occupancy information of the current node and the occupancy information of each of the plurality of reference nodes may be determined. In addition, the prediction direction for the current node may be determined based on the respective differences. By way of example, the prediction direction for the current node may be determined to be one of the plurality of candidate prediction directions that corresponds to one of the plurality of reference nodes corresponding to the smallest difference in the respective differences.

In some embodiments, the prediction direction for the current node may be determined further based on any other additional information, such as occupancy information of a parent node level of the current node, the number of mismatch occupancy bits of the parent node level, and/or the like.

In view of the above, the occupancy information of the current node and the occupancy information of each of a plurality of reference nodes for the current node are considered for determining the prediction direction of the current node. Thereby, the determination of the prediction direction can be performed more efficiently, and thus the coding efficiency can be improved.

In some embodiments, a PC sample may be a frame, a picture, a slice, a sub-frame, a sub-picture, a tile, a segment, or the like. In some embodiments, information regarding whether to and/or how to apply the method may be indicated in the bitstream. Additionally, the information regarding whether to and/or how to apply the method may be indicated in one of the following: a frame, a tile, a slice, or an octree.

In some embodiments, information regarding whether to and/or how to apply the method may be dependent on coded information. By way of example rather than limitation, the coded information may comprise a dimension, a color format, a color component, a slice type, a picture type, and/or the like.

According to further embodiments of the present disclosure, a non-transitory computer-readable recording medium is provided. The non-transitory computer-readable recording medium stores a bitstream of a point cloud sequence which is generated by a method performed by an apparatus for point cloud coding. In the method, a conversion between a current point cloud (PC) sample of the point cloud sequence and the bitstream is performed. A prediction direction for a current node in the current PC sample is indicated in the bitstream. The prediction direction corresponds to a first reference PC sample in a plurality of reference PC samples for the current PC sample, and a reference node in the first reference PC sample is used to determine a prediction of geometry information of the current node.

According to still further embodiments of the present disclosure, a method for storing a bitstream of a point cloud sequence is provided. In the method, a conversion between a current point cloud (PC) sample of the point cloud sequence and the bitstream is performed. A prediction direction for a current node in the current PC sample is indicated in the bitstream. The prediction direction corresponds to a first reference PC sample in a plurality of reference PC samples for the current PC sample, and a reference node in the first reference PC sample is used to determine a prediction of geometry information of the current node. Moreover, the bitstream is stored in a non-transitory computer-readable recording medium.

In view of the above, the solutions in accordance with some embodiments of the present disclosure can advantageously improve the coding efficiency.

Implementations of the present disclosure can be described in view of the following clauses, the features of which can be combined in any reasonable manner.

Clause 1. A method for point cloud coding, comprising: performing a conversion between a point cloud sequence and a bitstream of the point cloud sequence, wherein an output order of a plurality of point cloud (PC) samples of the point cloud sequence is dependent on time stamps of the plurality of PC samples.

Clause 2. The method of clause 1, wherein the output order is the same as a display order of the plurality of PC samples.

Clause 3. The method of clause 2, wherein the display order is the same as a coding order of the plurality of PC samples.

Clause 4. The method of clause 3, wherein a bi-directional prediction scheme is disabled for the plurality of PC samples.

Clause 5. The method of any of clauses 3-4, wherein the output order of the plurality of PC samples is the same as the coding order of the plurality of PC samples.

Clause 6. The method of clause 2, wherein the display order is different from a coding order of the plurality of PC samples.

Clause 7. The method of clause 6, wherein a bi-directional prediction scheme is enabled for at least one of the plurality of PC samples.

Clause 8. The method of any of clauses 6-7, wherein the output order of the plurality of PC samples is the different from the coding order of the plurality of PC samples.

Clause 9. The method of any of clauses 1-8, wherein a first indication indicates whether to output a first PC sample in the plurality of PC samples.

Clause 10. The method of clause 9, wherein the first indication is determined based on a time stamp of the most-recently outputted PC sample.

Clause 11. The method of clause 10, wherein if a time stamp of the first PC sample is equal to a sum of a time stamp step and the time stamp of the most-recently outputted PC sample, the first indication indicates that the first PC sample is to be outputted.

Clause 12. The method of clause 9, wherein the first indication is determined based on a time stamp of the most-recently outputted PC sample and a reference metric of the first PC sample, and the reference metric of the first PC sample indicates the number of times that the first PC sample is used as a reference PC sample for a PC sample to be coded.

Clause 13. The method of clause 12, wherein if a time stamp of the first PC sample is equal to a sum of a time stamp step and the time stamp of the most-recently outputted PC sample and the reference metric is equal to first value, the first indication indicates that the first PC sample is to be outputted.

Clause 14. The method of clause 13, wherein the first value is 0.

Clause 15. The method of any of clauses 9-14, wherein if the first indication indicates that the first PC sample is to be outputted, the first PC sample is outputted, or if the first PC sample is outputted, the first indication indicates that the first PC sample is not to be outputted.

Clause 16. The method of any of clauses 9-15, wherein the first indication is determined at a decoder for performing the conversion.

Clause 17. The method of any of clauses 9-16, wherein the first indication is updated during the conversion.

Clause 18. The method of any of clauses 1-17, wherein the conversion includes encoding the point cloud sequence into the bitstream, or the conversion includes decoding the point cloud sequence from the bitstream.

Clause 19. A method for point cloud coding, comprising: performing a conversion between a current point cloud (PC) sample of a point cloud sequence and a bitstream of the point cloud sequence, wherein a prediction direction for a current node in the current PC sample is indicated in the bitstream, the prediction direction corresponds to a first reference PC sample in a plurality of reference PC samples for the current PC sample, and a reference node in the first reference PC sample is used to determine a prediction of geometry information of the current node.

Clause 20. The method of clause 19, wherein the prediction direction is determined at an encoder for performing the conversion.

Clause 21. The method of any of clauses 19-20, wherein the prediction direction is indicated in the bitstream based on a condition.

Clause 22. The method of any of clauses 19-21, wherein if there are a plurality of reference PC samples for the current PC sample, the prediction direction is indicated in the bitstream, or if there are a plurality of reference nodes for the current node, the prediction direction is indicated in the bitstream, or if there are a plurality of candidate predictions for the geometry information of the current node, the prediction direction is indicated in the bitstream.

Clause 23. The method of any of clauses 19-22, wherein the bitstream comprise a first indication indicating the prediction direction for the current node.

Clause 24. The method of clause 23, wherein the first indication comprises one of the following: an index of the first reference PC sample, an index of a first candidate prediction in a list of candidate predictions for the geometry information of the current node, the first candidate prediction being used to code the current node, or an index of the prediction direction.

Clause 25. The method of any of clauses 23-24, wherein the first indication is determined at an encoder for performing the conversion.

Clause 26. The method of any of clauses 23-24, wherein the first indication is indicated in the bitstream.

Clause 27. The method of clause 26, wherein the first indication is coded with one of the following: a fixed-length coding, a unary coding, or a truncated unary coding.

Clause 28. The method of clause 26, wherein the first indication is coded in a predictive way.

Clause 29. The method of any of clauses 19-28, wherein the prediction direction for the current node is determined based on geometry information of the current node and geometry information of each of a plurality of reference nodes for the current node.

Clause 30. The method of clause 29, wherein the current node is a node in a predictive tree for the current PC sample and represents a single point in the current PC sample.

Clause 31. The method of clause 30, wherein more than one reference node is determined for each node in the predictive tree.

Clause 32. The method of any of clauses 29-31, wherein the geometry information of the current node or the geometry information of each of the plurality of reference nodes is represented in a form of geometric coordinates.

Clause 33. The method of clause 32, wherein the geometric coordinates is in a Euclidean coordinate system or a spherical coordinate system.

Clause 34. The method of any of clauses 29-33, wherein the prediction direction for the current node is determined from a plurality of candidate prediction directions for the current node, and each of the plurality of candidate prediction directions corresponds to one of the plurality of reference PC samples for the current PC sample.

Clause 35. The method of clause 34, wherein respective differences between the geometry information of the current node and the geometry information of each of the plurality of reference nodes are determined.

Clause 36. The method of clause 35, wherein the prediction direction for the current node is determined based on the respective differences.

Clause 37. The method of clause 36, wherein the prediction direction for the current node is determined to be one of the plurality of candidate prediction directions that corresponds to a reference PC sample comprising a reference node corresponding to the smallest difference in the respective differences.

Clause 38. The method of any of clauses 29-37, wherein the prediction direction for the current node is determined further based on at least one of the following: occupancy information of a parent node level of the current node, or the number of mismatch occupancy bits of the parent node level.

Clause 39. The method of any of clauses 19-28, wherein the current node is a node in a tree structure for spatial partition of the current PC sample and represents at least a portion of the current PC sample.

Clause 40. The method of clause 39, wherein the tree structure is an octree structure.

Clause 41. The method of any of clauses 38-39, wherein each non-root node in the tree structure corresponds to a parent node.

Clause 42. The method of clause 41, wherein more than one reference nodes is determined for the parent node.

Clause 43. The method of any of clauses 38-42, wherein more than one reference node is determined for each node in the tree structure.

Clause 44. The method of any of clauses 38-43, wherein the prediction direction for the current node is determined from a plurality of candidate prediction directions for the current node, and each of the plurality of candidate prediction directions corresponds to one of a plurality of reference PC nodes for the current node.

Clause 45. The method of any of clauses 38-44, wherein the prediction direction for the current node is determined based on planar information of a parent node of the current node and planar information of each of a set of reference nodes for the parent node of the current node.

Clause 46. The method of clause 45, wherein planar information of a node indicates respective point distributions in two half node spaces obtained by dividing the node along a direction.

Clause 47. The method of clause 46, wherein a plurality of indications indicates the respective point distributions in the two half node spaces.

Clause 48. The method of any of clauses 45-46, wherein the direction is one of the following: an x-axis direction, a y-axis direction, or a z-axis direction.

Clause 49. The method of any of clauses 45-48, wherein the planar information of the parent node of the current node and the planar information of each of the set of reference nodes for the parent node are used to determine a prediction direction for each child node of the parent node.

Clause 50. The method of any of clauses 45-49, wherein the prediction direction for the current node is determined from a plurality of candidate prediction directions for the current node, and each of the plurality of candidate prediction directions corresponds to one of the set of reference nodes for the parent node of the current node and one of a plurality of reference PC nodes for the current node.

Clause 51. The method of clause 50, wherein respective differences between the planar information of the parent node of the current node and the planar information of each of the set of reference nodes for the parent node of the current node are determined.

Clause 52. The method of clause 51, wherein the prediction direction for the current node is determined based on the respective differences.

Clause 53. The method of clause 52, wherein the prediction direction for the current node is determined to be one of the plurality of candidate prediction directions that corresponds to one of the set of reference nodes corresponding to the smallest difference in the respective differences.

Clause 54. The method of any of clauses 45-53, wherein the prediction direction for the current node is determined further based on at least one of the following: occupancy information of a parent node level of the current node, or the number of mismatch occupancy bits of the parent node level.

Clause 55. The method of any of clauses 38-44, wherein the prediction direction for the current node is determined based on occupancy information of the current node and occupancy information of each of a plurality of reference nodes for the current node.

Clause 56. The method of clauses 55, wherein the occupancy information of the current node or the occupancy information of each of a plurality of reference nodes is indicated by an occupancy code.

Clause 57. The method of any of clauses 55-56, wherein respective differences between the occupancy information of the current node and the occupancy information of each of the plurality of reference nodes are determined.

Clause 58. The method of clause 57, wherein the prediction direction for the current node is determined based on the respective differences.

Clause 59. The method of clause 58, wherein the prediction direction for the current node is determined to be one of the plurality of candidate prediction directions that corresponds to one of the plurality of reference nodes corresponding to the smallest difference in the respective differences.

Clause 60. The method of any of clauses 55-59, wherein the prediction direction for the current node is determined further based on at least one of the following: occupancy information of a parent node level of the current node, or the number of mismatch occupancy bits of the parent node level.

Clause 61. The method of any of clauses 19-60, wherein the conversion includes encoding the current PC sample into the bitstream.

Clause 62. The method of any of clauses 19-60, wherein the conversion includes decoding the current PC sample from the bitstream.

Clause 63. The method of any of clauses 1-62, wherein a PC sample is one of the following: a frame, a picture, a slice, a sub-frame, a sub-picture, a tile, or a segment.

Clause 64. The method of any of clauses 1-63, wherein information regarding whether to and/or how to apply the method is indicated in the bitstream.

Clause 65. The method of any of clauses 1-64, wherein information regarding whether to and/or how to apply the method is indicated in one of the following: a frame, a tile, a slice, or an octree.

Clause 66. The method of any of clauses 1-64, wherein information regarding whether to and/or how to apply the method is dependent on coded information.

Clause 67. The method of clause 65, wherein the coded information comprises at least one of the following: a dimension, a color format, a color component, a slice type, or a picture type.

Clause 68. An apparatus for point cloud coding comprising a processor and a non-transitory memory with instructions thereon, wherein the instructions upon execution by the processor, cause the processor to perform a method in accordance with any of clauses 1-18.

Clause 69. A non-transitory computer-readable storage medium storing instructions that cause a processor to perform a method in accordance with any of clauses 1-18.

Clause 70. A non-transitory computer-readable recording medium storing a bitstream of a point cloud sequence which is generated by a method performed by an apparatus for point cloud coding, wherein the method comprises: performing a conversion between the point cloud sequence and the bitstream, wherein an output order of a plurality of point cloud (PC) samples of the point cloud sequence is dependent on time stamps of the plurality of PC samples.

Clause 71. A method for storing a bitstream of a point cloud sequence, comprising: performing a conversion between the point cloud sequence and the bitstream, wherein an output order of a plurality of point cloud (PC) samples of the point cloud sequence is dependent on time stamps of the plurality of PC samples; and storing the bitstream in a non-transitory computer-readable recording medium.

Clause 72. A non-transitory computer-readable recording medium storing a bitstream of a point cloud sequence which is generated by a method performed by an apparatus for point cloud coding, wherein the method comprises: performing a conversion between a current point cloud (PC) sample of the point cloud sequence and the bitstream, wherein a prediction direction for a current node in the current PC sample is indicated in the bitstream, the prediction direction corresponds to a first reference PC sample in a plurality of reference PC samples for the current PC sample, and a reference node in the first reference PC sample is used to determine a prediction of geometry information of the current node.

Clause 73. A method for storing a bitstream of a point cloud sequence, comprising: performing a conversion between a current point cloud (PC) sample of the point cloud sequence and the bitstream, wherein a prediction direction for a current node in the current PC sample is indicated in the bitstream, the prediction direction corresponds to a first reference PC sample in a plurality of reference PC samples for the current PC sample, and a reference node in the first reference PC sample is used to determine a prediction of geometry information of the current node; and storing the bitstream in a non-transitory computer-readable recording medium.

### Example Device

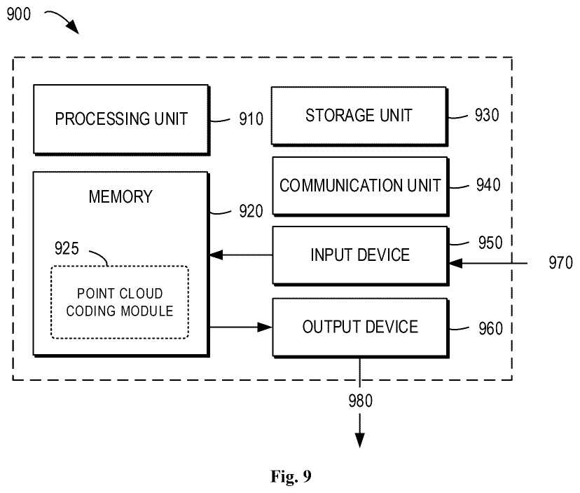

FIG. 9 illustrates a block diagram of a computing device 900 in which various embodiments of the present disclosure can be implemented. The computing device 900 may be implemented as or included in the source device 110 (or the GPCC encoder 116 or 200) or the destination device 120 (or the GPCC decoder 126 or 300).

It would be appreciated that the computing device 900 shown in FIG. 9 is merely for purpose of illustration, without suggesting any limitation to the functions and scopes of the embodiments of the present disclosure in any manner.

As shown in FIG. 9, the computing device 900 includes a general-purpose computing device 900. The computing device 900 may at least comprise one or more processors or processing units 910, a memory 920, a storage unit 930, one or more communication units 940, one or more input devices 950, and one or more output devices 960.

In some embodiments, the computing device 900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 900 can support any type of interface to a user (such as “wearable” circuitry and the like).

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem and the like) enabling the computing device 900 to communicate with one or more other computing devices, if required. Such communication can be performed via input/output (I/O) interfaces (not shown).

In some embodiments, instead of being integrated in a single device, some or all components of the computing device 900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 900 may be used to implement point cloud encoding/decoding in embodiments of the present disclosure. The memory 920 may include one or more point cloud coding modules 925 having one or more program instructions. These modules are accessible and executable by the processing unit 910 to perform the functionalities of the various embodiments described herein.

In the example embodiments of performing point cloud encoding, the input device 950 may receive point cloud data as an input 970 to be encoded. The point cloud data may be processed, for example, by the point cloud coding module 925, to generate an encoded bitstream. The encoded bitstream may be provided via the output device 960 as an output 980.

In the example embodiments of performing point cloud decoding, the input device 950 may receive an encoded bitstream as the input 970. The encoded bitstream may be processed, for example, by the point cloud coding module 925, to generate decoded point cloud data. The decoded point cloud data may be provided via the output device 960 as the output 980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for point cloud coding, comprising:
performing a conversion between a current point cloud (PC) sample of a point cloud sequence and a bitstream of the point cloud sequence, wherein a prediction direction for a current node in the current PC sample is indicated in the bitstream, the prediction direction corresponds to a reference PC sample in a plurality of reference PC samples for the current PC sample, and a reference node in the reference PC sample corresponding to the prediction direction is used to determine a prediction of geometry information of the current node.

2. The method of claim 1, wherein the point cloud sequence further comprises a first PC sample different from the current PC sample, and whether a prediction direction for a first node in the first PC sample is indicated in the bitstream is determined based on a condition.

3. The method of claim 2, wherein the condition comprises whether there is more than one reference PC sample for the first PC sample.

4. The method of claim 3, wherein if there is no more than one reference PC sample for the first PC sample, the prediction direction for the first node is not indicated in the bitstream.

5. The method of claim 1, wherein the bitstream comprises a first indication indicating the prediction direction for the current node.

6. The method of claim 5, wherein the first indication equal to a first value indicates that a first reference PC sample is used for inter prediction of the current node, and the first indication equal to a second value indicates that a second reference PC sample is used for inter prediction of the current node.

7. The method of claim 1, wherein the current node is a node in a predictive tree for the current PC sample.

8. The method of claim 1, wherein the point cloud sequence further comprises a second PC sample different from the current PC sample, and a prediction direction for a second node in the second PC sample is determined based on occupancy information of a parent node of the second node and occupancy information of each of a plurality of reference nodes for the parent node.

9. The method of claim 8, wherein the second node is a node in a occupancy tree for spatial partition of the second PC sample.

10. The method of claim 8, wherein the occupancy information of the parent node or the occupancy information of each of the plurality of reference nodes is indicated by an occupancy code.

11. The method of claim 8, wherein respective differences between the occupancy information of the parent node and the occupancy information of each of the plurality of reference nodes are determined.

12. The method of claim 11, wherein the prediction direction for the second node is determined based on the respective differences.

13. The method of claim 12, wherein the prediction direction for the second node is determined to be a prediction direction that corresponds to one of the plurality of reference nodes corresponding to the smallest difference in the respective differences.

14. The method of claim 11, wherein a difference between the occupancy information of the parent node and the occupancy information of a reference node of the parent node is determined based on the number of mismatch occupancy bits.

15. The method of claim 1, wherein a PC sample is one of the following:
a frame,
a picture,
a slice,
a sub-frame,
a sub-picture,
a tile, or
a segment.

16. The method of claim 1, wherein the conversion includes encoding the current PC sample into the bitstream.

17. The method of claim 1, wherein the conversion includes decoding the current PC sample from the bitstream.

18. An apparatus for point cloud coding comprising a processor and a non-transitory memory with instructions thereon, wherein the instructions upon execution by the processor, cause the processor to perform acts comprising:
performing a conversion between a current point cloud (PC) sample of a point cloud sequence and a bitstream of the point cloud sequence, wherein a prediction direction for a current node in the current PC sample is indicated in the bitstream, the prediction direction corresponds to a reference PC sample in a plurality of reference PC samples for the current PC sample, and a reference node in the reference PC sample corresponding to the prediction direction is used to determine a prediction of geometry information of the current node.

19. A non-transitory computer-readable storage medium storing instructions that cause a processor to perform acts comprising:
performing a conversion between a current point cloud (PC) sample of a point cloud sequence and a bitstream of the point cloud sequence, wherein a prediction direction for a current node in the current PC sample is indicated in the bitstream, the prediction direction corresponds to a reference PC sample in a plurality of reference PC samples for the current PC sample, and a reference node in the reference PC sample corresponding to the prediction direction is used to determine a prediction of geometry information of the current node.

20. A non-transitory computer-readable recording medium storing a bitstream of a point cloud sequence which is generated by a method performed by an apparatus for point cloud coding, wherein the method comprises:
performing a conversion between a current point cloud (PC) sample of the point cloud sequence and the bitstream, wherein a prediction direction for a current node in the current PC sample is indicated in the bitstream, the prediction direction corresponds to a reference PC sample in a plurality of reference PC samples for the current PC sample, and a reference node in the reference PC sample corresponding to the prediction direction is used to determine a prediction of geometry information of the current node.
